(19) United States
(12) Patent Application Publication
(10) Pub. No.: US 2014/0118807 A1
(43) Pub. Date: May 1, 2014

(54) HOLOGRAPHIC RECONSTRUCTING DEVICE AND APPLICATION ADAPTED TO PORTABLE ELECTRONIC PRODUCTS

(71) Applicant: Sheng-Pin Su, Taoyuan (TW)

(72) Inventor: Sheng-Pin Su, Taoyuan (TW)

(73) Assignee: TPK TOUCH SOLUTIONS INC., Taipei (TW)

(21) Appl. No.: 13/988,345

(22) PCT Filed: Oct. 19, 2011
(86) PCT No.: PCT/CN2011/080982

§ 371 Date: Jan. 5, 2014

(30) Foreign Application Priority Data
Nov. 18, 2010 (CN) 201010560117.7

(51) Int. Cl. G03H 1/22

(52) U.S. Cl. CPC G03H 1/2202
USPC 359/22

(57) ABSTRACT

Disclosed are a holographic reconstructing device and its application for portable electronic products. The holographic reconstructing device includes a compound hologram (9), a hologram seat (91), and a rebuilding light source (12). The compound hologram (9) is a flat-disk contour and disposed on the hologram seat (91). The rebuilding light source (12) is an LED and disposed under the hologram seat (91). The LED takes advantage of a small magnitude, less electricity consumption, simplified components, and a narrow bandwidth to definite a rebuilt image. The application of the flat-disk compound hologram is in a smooth-lying placement while reconstructing, which preferably occupies less space and facilitates user's observation as the rebuilt image is placed on the top of the compound hologram. The embedding of the holographic reconstructing device into the products would not affect the dimension of the products, thereby exhibiting realistic images on an individual space and forming a strong visual, clear impression, and a newly entertaining effect.

### BACKGROUND OF THE INVENTION

1. Field of the Invention

The present invention relates to an image reconstructing device, in particular to a holographic reconstructing device and its application adapted to portable electronic products.

2. Description of the Related Art

The common portable electronic products, like mobile phones, notebooks, PDAs, cameras, and relevant projectors, can typically present images on a display screen but cannot individually show them on an individual free space. A holography is well-known developed to bring the products an individual performance on the free space.

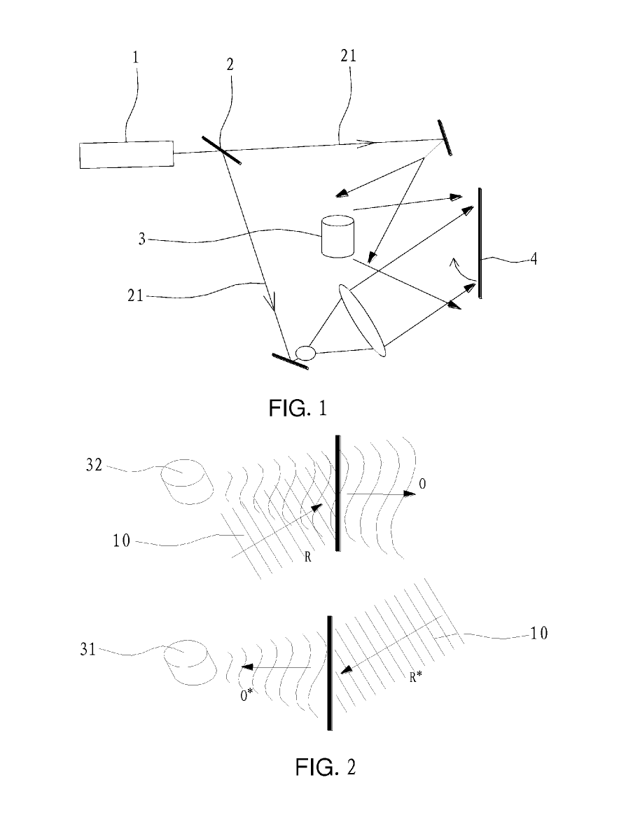

Generally, a modern holography is such a technology that makes use of an interference and a diffraction for attaining the reappearance of the wavefront of the object wave. Concerning to such technique, two steps are required. In the first shooting as shown in FIG. 1, the application of interference records the object wave, i.e. a laser is emitted from a laser emitter 1 and divided through a beamsplitter 2 into object beams 21 and reference beams 22. When the object beams 21 shoot on the object 3, the diffusion of the object beams 21 would superimpose on the reference beams 22 for creating interference, and each phase as well as amplitude on the wave of the object 3 would be converted into a strength value adapted to the varied space. Thereafter, a contrast and an interval between the interference fringes indicative of details of the object wave would be recorded by a plate 4. After developing and fixing the plate with interference fringes, a finished hologram, so called holograph, is accomplished. In the second procedure for rebuilding or reconstructing image as shown in FIG. 2, the application of diffraction makes the object wave reappeared. Commonly, the hologram as a complex grating image would perform two images under the irradiation of a rebuilt coherent laser 10. The images are named by a real image 31 (i.e. initial image) and a virtual image 32 (i.e. conjugate image). The images are strongly stereoscopic for providing a real vision effect.

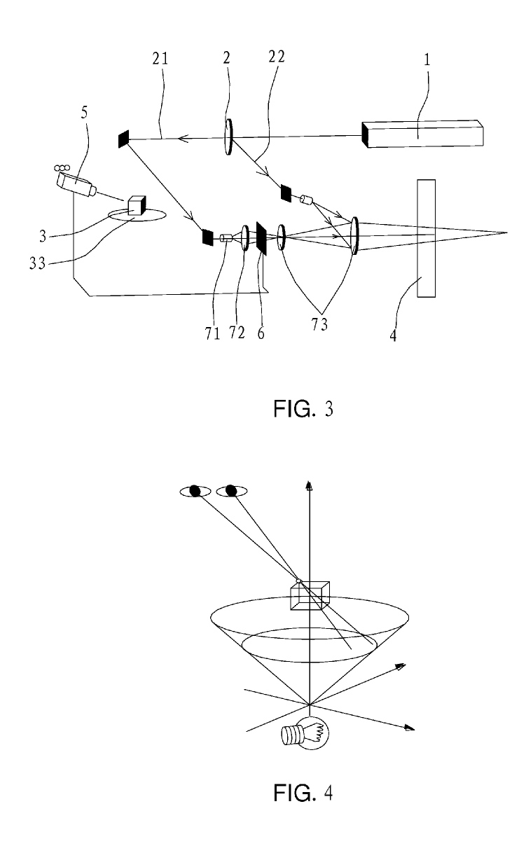

Until now, the holography has been improved and developed. It is now popular to one skilled in the art that white light is allowably used for rebuilding stereo images in a compound holographic field. Such field combines the theory of rainbow holography and common shooting. Referring to FIG. 3 showing a compound imaging device comprises a light source 1, a reflecting minor, a beamsplitter 2, a camera 5, an LCD 6, a platform 33, and a plate base 41. Wherein, the camera 5 is located upon the platform 33 for revolving around the platform 33 by an angle, or the platform 33 makes a self-revolution when the camera 5 is static. The camera 5 herein serves to transmit three-dimensional images to the LCD 6 for a performance. When the light source 1 emits a laser to the beamsplitter 2, the beamsplitter 2 divides the laser into object beams 21 and reference beams 22. The object beams enter a wave filtrate device 71 through the reflecting mirror and reach a light convergent mirror 72, from which the light penetrates the LCD 6 and then permits the three-dimensional image of the object to pass through lenses 73. The images are hence intervened in the off-axis references beams 22 and are shot to a plate 4 on the rotative plate base 41. The rotation speed of the plate base 41 corresponds to that of the platform 33. A set of interference fringes is formed after exposing the image to the plate 4 and a finished compound hologram 9 ensues after developing and fixing the plate 4.

The application of a coherent light to the shooting of the compound hologram and the white light used in the rebuilding thereof would leads to a separation of the rebuilt image into seven colors like rainbows. It is because the white light has property of seven colors with divergent refractions. In contrast, in the event of the application of white light during the shooting, the light diffraction efficiency by the penetration of light through the plate will be promoted under the control on the parameters indicative of the angle of the camera and the platform, the rotation velocity of the platform or the camera, and the exposure areas of the plate. Furthermore, the reconstruction of the hologram could still select the white light although a main problem attendant with the white light, i.e. seven-color beams, is devoid of sufficient clearness as a result of the complicate self-components and the wider photo-tape.

After the publication of the compound holography, people successively develop the compound hologram having a cone, column, and other types. Wherein, the application of the conical compound hologram is to flatten the conical surface and re-furl it after the plate images in the shooting. The application of the column hologram is to flatten the column surface and re-furl it after the plate images in the shooting. As shown in FIGS. 4 and 5, a white light with respect to the direction of the reference beams is placed under the compound hologram while rebuilding and is generally adopted by a fluorescent lamp. The light passing through the hologram forms a real image on the top of the conical compound hologram and forms a virtual image in a chamber of the column compound hologram. By means of the optical aberration, the right-bias images are visible to the left eye, and the left-bias images are visible to the right eye. Therefore, those parallactical images sent to the brain would be interpreted as a three-dimensional stereo image.

The aforementioned conical and column compound hologram used in the image rebuilt system concludes that the plate has to be placed upright while rebuilding and the rebuilding light requires large magnitude, high electricity, and high costs. In addition, once the user stands under the image of the conical compound hologram or stands on or below the column hologram, the observing angle would be affected and leads to him or her failure to see the rebuilt image. Therefore, such typical image reconstructing device can not be adapted to the present portable electronic products.

Thus, the applicant of the present invention dedicates himself to the research of the holographic reconstructing device and designs one with newly invention which permissibly cooperates with the current portable electronic products.

SUMMARY OF THE INVENTION

An object of the present invention is to provide a holographic reconstructing device which rebuilds a definite image, facilitates users' observation, and attains a small magnitude, low electricity consumption as well as a simplified construction.

Another object of the present invention is to provide a portable electronic product capable of rebuilding hologram, so that the product with a dimension thereof in conformity with that of the common electronic product could individually perform a realistic stereo image in a free space and conduce to a convenient observation.

To obtain afore objects, a holographic reconstructing device in accordance with the present invention includes a compound hologram, a hologram seat, and a rebuilding light. Wherein, the compound hologram is shaped of a flat-disk contour and disposed on the hologram seat; the rebuilding light adopts an LED and is disposed beneath the hologram seat.

Preferably, the hologram seat serves as a body of the holographic reconstructing device.

Preferably, the device further includes a driving mechanism serving to rotate the hologram seat and thence drive a rotation of the compound hologram.

Preferably, the driving mechanism includes a motor and a decelerating gear assembly. Wherein, the decelerating gear assembly has a small gear and a large gear. The small gear connects to the motor, and the large gear attaches to a circumference of the hologram seat, so as to allow the motor to rotate the hologram seat through the decelerating gear assembly.

Preferably, the driving mechanism includes a combination of motor and band wheel or a combination of motor and chain.

Preferably, the device further includes a body; the hologram seat is rotatably mounted on the body, and the driving mechanism and the LED are mounted on the body as well.

Preferably, the LED is made by white light.

Preferably, the LED is made by mono-colorful light.

Preferably, the LED is made by light with an assortment of colors whose color variation and combination are manipulated by a program controller.

Preferably, a reference beam is coaxial with respect to a spindle of a disk plate when the compound hologram is under shooting; the LED is disposed on a substrate right below the hologram seat and located true to an axis of the compound hologram.

Preferably, a reference beam deviates from a spindle of a disk plate when the compound hologram is under shooting; the LED is disposed on a substrate under the hologram seat and located off an axis of the compound hologram.

Preferably, the compound hologram has adjacent twice exposure areas that are overlapped.

Preferably, a transparent protective layer covers a surface where the compound hologram contacts with the outside.

Preferably, the transparent protective layer is made of glass, PET, or PMMA.

Preferably, under the shooting of the compound hologram, a camera shooting angle is ranged from 30° to 40°, a revolving angle of the disk plate and an object is ranged from 0.1° to 1°, an incident angle of an object beam is ranged from 30° to 45°, and a distance between a convergence of the object beam and the disk plate is ranged from 10 to 20 cm.

A portable electronic product capable of rebuilding holograms in accordance with the present invention includes a main body with a window; the holographic reconstructing device as mentioned supra is mounted within the window and electrically connects to a power supply of the electronic product.

Preferably, the portable electronic product adopts a mobile phone, a notebook, a PDA, a camera, a projector, etc.

By comparing with the traditional image reconstructing device, the present invention has following advantages. 1. The present invention adopts an LED as a rebuilding light which is beneficial to a small magnitude and to simplified components as well as a narrow bandwidth since the white light of the LED is only mixed by Red, Green, and Blue. Therefore, the image reconstructed by the LED is much clear. Further, the LED could be shifted by a program controller for the color alteration, thereby providing multiple light emissions to fit for colorful light source used in the shooting and thence to reedify definite images or project specific colors on the rebuilt images, so as to obtain a splendid performance. 2. The application of the flat-disk compound hologram is in a way of smooth-lying position while rebuilding, which preferably occupies less space and facilitates user's observation as the rebuilt image is placed on the top of the compound hologram. To sum up, the instant image reconstructing device with features of miniaturization, flattened module, and simplified construction would be allowed to embed into varies portable digital products, such as mobile phones, notebooks, PDAs, cameras, display projectors, etc. Accordingly, these products could exhibit realistic images on an individual space and form a strong visual and clear impression, hence increasing the entertainment effect.

The advantages of the present invention over the known prior arts will become more apparent to those of ordinary skilled in the art by reading the following descriptions with the relating drawings.

BRIEF DESCRIPTION OF THE DRAWINGS

FIG. 1 is a schematic view showing the shooting of a conventional invention;

FIG. 2 is a schematic view showing the rebuilding of the conventional hologram;

FIG. 3 is a schematic view showing the shooting of a conventional compound hologram;

FIG. 4 is a schematic view showing the rebuilding of a conical compound hologram;

FIG. 5 is a schematic view showing the rebuilding of a column-type compound hologram;

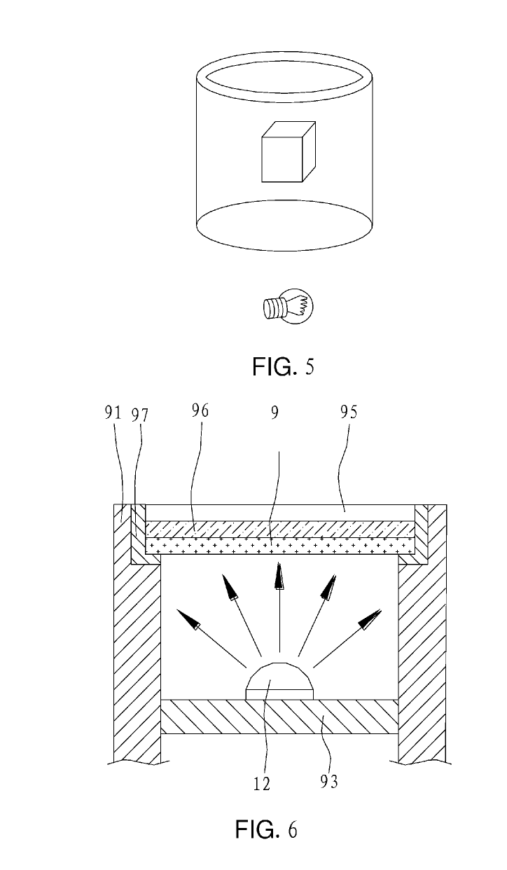

FIG. 6 is a cross-sectional view showing a holographic reconstructing device of the present invention;

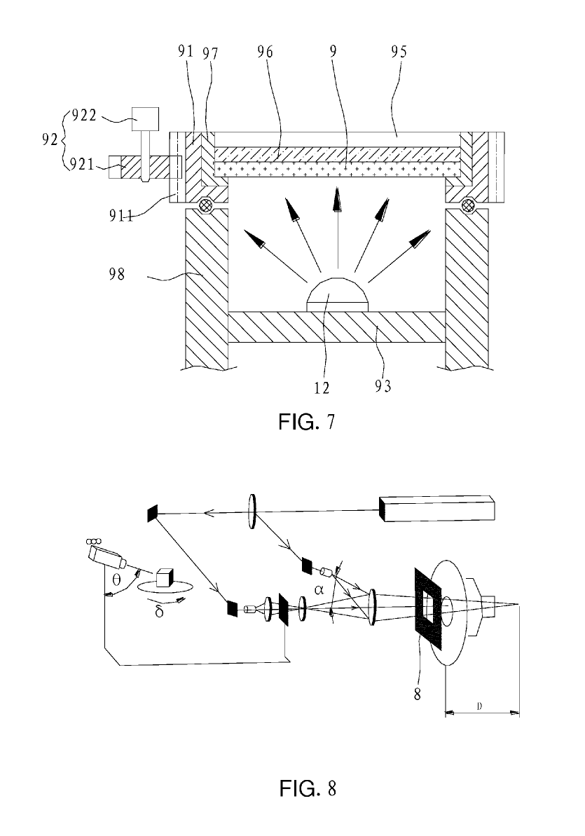

FIG. 7 is a cross-sectional view showing a driving mechanism on the holographic reconstructing device of the present invention;

FIG. 8 is a schematic view showing the shooting of the present compound hologram;

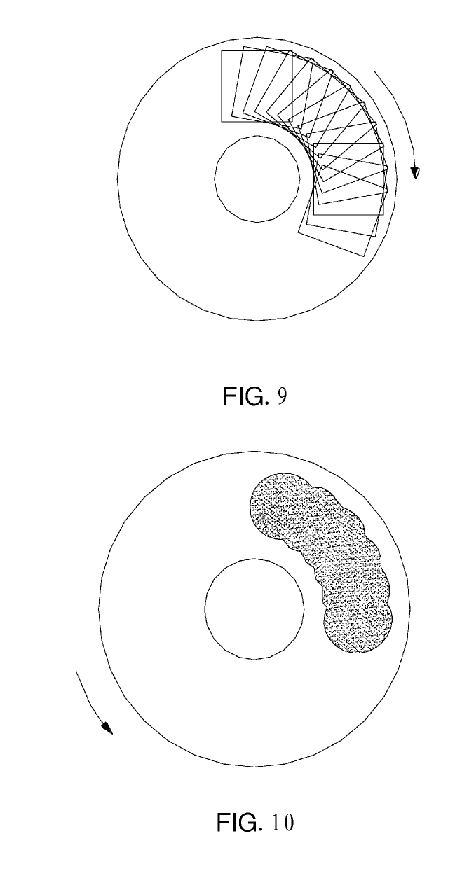

FIG. 9 is a schematic view showing the overlapped exposure areas formed by a square contour on the compound hologram;

FIG. 10 is a schematic view showing the overlapped exposure areas formed by a circular contour on the compound hologram;

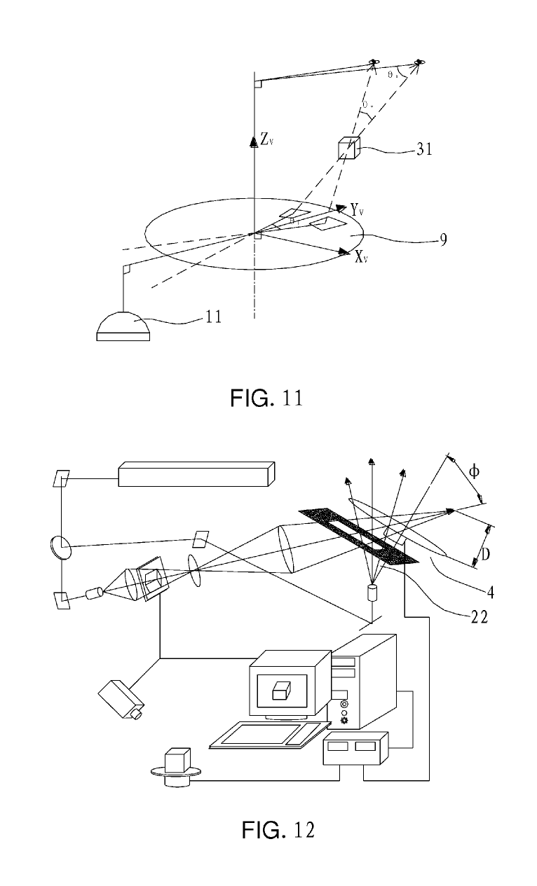

FIG. 11 is a schematic view showing the rebuilding of an off-axially disk like compound hologram of the present invention;

FIG. 12 is a schematic view showing the shooting of a coaxially disk like compound hologram of the present invention;

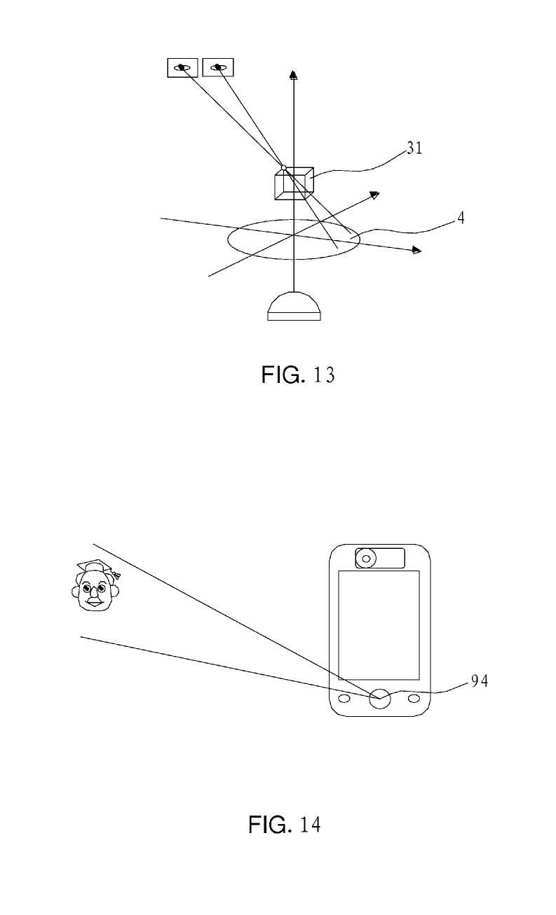

FIG. 13 is a schematic view showing the rebuilding of a coaxially disk like compound hologram of the present invention;

FIG. 14 is a schematic view showing the rebuilding of the present holographic reconstructing device applied to a mobile phone;

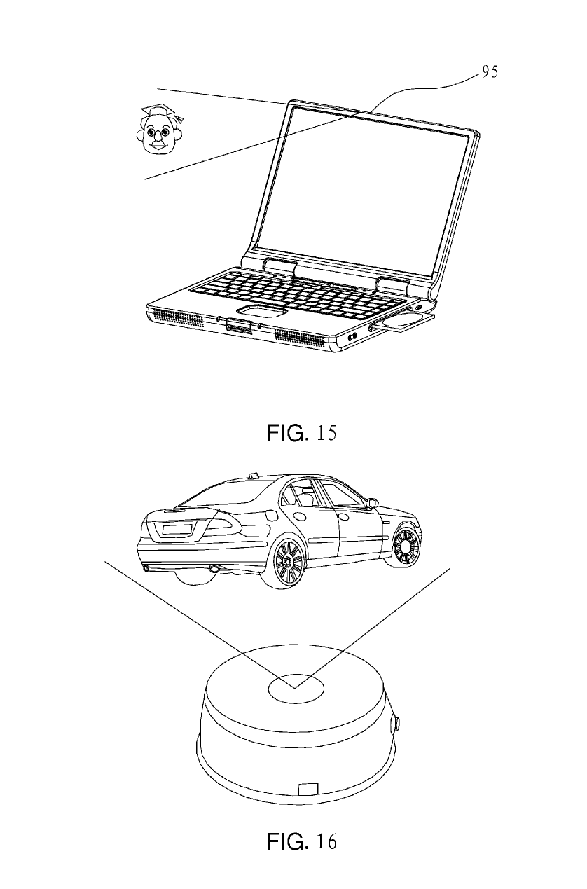

FIG. 15 is a schematic view showing the rebuilding of the present holographic reconstructing device applied to a notebook; and

FIG. 16 is a schematic view showing the rebuilding of the present holographic reconstructing device applied to a displaying device.

### DESCRIPTION OF THE REFERENCE NUMERALS

1 laser emitter 10 rebuilt coherent laser
11 white light 12 LED
2 beamsplitter 21 object beam
22 reference beam 3 object
31 real image 32 virtual image
33 platform 4 plate
41 turning base 5 camera
6 LCD 71 wave filtrate device
72 light convergent mirror 73 lens
8 shadow mask 9 disk-shaped compound hologram
91 hologram seat 92 driving mechanism
93 substrate 94 window
95 protective layer 96 transparent conducting gel
97 frame 98 body

### DETAILED DESCRIPTION OF THE PREFERRED EMBODIMENTS

Referring to FIG. 6, a holographic reconstructing device in accordance with the present invention includes a compound hologram 9, a hologram seat 91, and a rebuilding light 12. Wherein, the compound hologram 9 is shaped of a flat-disk contour. To prevent the compound hologram 9 from being damaged while contacting with the outside and avoid affecting the imaging of the hologram 9, a protective layer 95 made of transparent material is preferably used to cover an exposed or a non-exposed surface where the compound hologram 9 contacts with the outside. Alternatively, both surfaces thereof can be coated with the protective layer. The transparent material could be glass, PET, or PMMA. The protective layer 95 is adhered to the compound hologram 9 by a transparent conducting gel 96. Around the circumference of the protective layer 95 and the compound hologram 9 has a frame 97 sleeved thereon to prevent the damage caused by the friction or collision of the protective layer 95 and the compound hologram 9 with the hologram seat 91 when they are disposed in or removed from the seat 91.

Referring to FIG. 8, the disk-shaped compound hologram 9 is executed by the shooting of the compound imaging device. The difference between a disk-shaped compound imaging device of FIG. 8 and that of FIG. 3 is that the present embodiment disposes a shadow mask 8 with a square or circular aperture between a set of lenses 73 and a plate 4. Accompanying with FIG. 9 which shows that the compound hologram 9 has exposure areas mutually overlapped when object beam 21 and reference beam 22 reciprocally interference and are shot on a disk plate 4 on a turning base 41. That is, the second exposure area would superimpose on the first exposure area, and the serried area could shape into a square formation as illustrated in FIG. 9, circular shape as illustrated in FIG. 10, or other proper contours pursuant to the aperture contour of the shadow mask 8. Although the light diffraction would be decreased in view of multiple exposures impinging on the identical position of the disk-shaped compound hologram, the diffraction could still be sustained as long as the parameters indicative of the angle of the camera, the rotation velocity of the disk plate and the object, the incident angle of the object beams or the reference beams, and the scope of the exposure areas are optimized in the shooting. Herein, FIG. 8 performs that a camera shooting angle θ of the camera is ranged from 30° to 40°, a revolving angle δ of the disk plate 4 and an object 3 is limited from 0.1° to 1°, and an incident angle α of the reference beam 22 is from 30° to 90°, concurrently the object beam 21 is coaxial with respect to a spindle of the disk plate 4. Further, a distance D between a convergence of the object beam 21 and the disk plate 4 is ranged from 10 to 20 cm. The parameters may be shown in FIG. 12, an incident angle φ of an object beam is ranged between 30° and 45, and concurrently the reference beam 22 is coaxial with respect to the disk plate 4; further, the distance D between a convergence of the object beam 21 and the disk plate 4 is still ranged from 10 to 20 cm. Such parameters as mentioned supra assist the shooting compound hologram in rebuilding or reconstructing clear images.

Referring to FIG. 8, since the reference beam 22 intersects with an axis of the disk plate 4, the disk-shaped compound hologram 9 would perform in an off-axis imaging and the rebuilt image would be presented on the spindle deviating from the top of the disk plate 4 (as shown in FIG. 11). In FIG. 12, if the reference beam 22 and the spindle of the disk plate 4 are coaxial in the shooting, the disk-shaped compound hologram 9 would coaxially image, which leads to the rebuilt image presenting on an axial line off the right top of the disk plate 4 (as shown in FIG. 13). By means of the optical aberration, the right-bias images are visible to the left eye, and the left-bias images are visible to the right eye. Therefore, those parallactical images sent to the brain would be interpreted as a three-dimensional stereo image.

Referring to FIG. 6, the hologram seat 91 serves to receive the disk-shaped compound hologram 9, or the hologram seat 91 can be as a body of the holographic reconstructing device itself. When the hologram seat 91 does not rotate, the disk-shaped compound hologram 9 rebuilds a static image. Referring to FIG. 7, the hologram seat 91 can also be a part of the body 98 of the holographic reconstructing device. Between the hologram seat 91 and body 98 mounts a bearing, and the hologram seat 91 connects to a driving mechanism 92. The driving mechanism 92 includes a motor 922 and a decelerating gear assembly 911,921. Wherein, the decelerating gear assembly has a small gear 921 and a large gear 911. The small gear 921 connects to the motor 922, and the large gear 911 attaches to a circumference of the hologram seat 91, so as to allow the driving mechanism 92 to rotate the hologram seat 91 and further trigger the rotation of the disk-shaped compound hologram 9 for rebuilding dynamic images. Besides, the driving mechanism 92 can adopt other means for rotating the hologram seat 91, for example sets of band wheel or chain. In order to remain the clearness of the rebuilt image and decrease the distortion, the rotating speed of the hologram 9 and the turning speed of the shooting are the same.

Referring to FIG. 6, a rebuilding light 12 under the hologram seat 91 adopts an LED and is located on a substrate 93 or on adequate structure adapting to fix the LED. The substrate 93 is a mass PCB plate utilized in electron industry. The substrate 93 is mounted on the base 98. In case of the compound hologram 9 imaging by the off-axis manner, the LED 12 disposed under the hologram seat 91 would deviate from the axis of the hologram 9 for being located on the position of the reference beam while shooting, so as to attain a clear rebuilt image (as shown in FIG. 11). Whereas, if the disk-shaped compound hologram 9 coaxially images, the LED 12 right below the hologram seat 91 would be placed on the position of the reference beam when shooting on the axis of the hologram 9 (as shown in FIG. 13). Herein, the LED 12 could be made either by white light, mono-colorful light, light with an assortment of colors, or changeable color lights. When the LED 12 adopts either changeable or divergent colors of lights, its color variation and combination are manipulated by a program controller, whereby the rebuilt image could present copious colors and diverse effect according to the color variation.

Two features are essentially included in the present invention. First, the present invention adopts a disk-shaped compound hologram which could be preferably molded and replicated by a compression printing. Such hologram could be easily manufactured with low costs and be in a mass production. By comparing with the typical conical or column hologram, the present disk-shaped compound hologram conduces to reduce the magnitude of the image reconstructing device. Further, the rebuilt image is placed on the top of the compound hologram, therefore the user could overall look around the image without limitation and attain a preferable observation. Second, since the application of the compound hologram essentially permits the use of incoherent light for rebuilding images without the utilization of coherent light, an LED as a rebuilding light is preferably adopted in the present invention. If the LED adopts white light mixed by Red, Green, and Blue, simplified components as well as a narrow bandwidth are attained to clarify the rebuilt image. In case of the LED capable of changing colors or made by diverse colors, the LED could be shifted by a program controller for a color alteration, thereby providing multi-light emissions to fit for colorful light source used in the shooting and thence to reedify definite images, thereby projecting full or specific colors on the rebuilt images and obtaining a splendid performance. In addition, the disk-shaped compound hologram and LED have small magnitude, which leads to the 3D image reconstructing device of the present invention flattening, miniaturizing, and easily embedding into the current portable electronic products, like mobile phones, notebooks, cameras, PDAs, etc.

Referring to FIG. 14, a mobile phone capable of rebuilding holograms in accordance with the present invention includes a main body with a window 94; the LED, hologram seat, driving mechanism, and disk-shaped compound hologram as mentioned supra are mounted within the window 94. The LED and the driving mechanism electrically connect to a power supply of the phone, and the hologram seat is disposed at the front of the LED for engaging with the driving mechanism. The disk-shaped compound hologram is disposed on the hologram seat. As long as the disk-shaped compound hologram records a static image, like a cartoon feature as shown in FIG. 14, the driving mechanism would not operate. Under the irradiation of the LED toward the rebuilt image, a static cartoon image could be presented at the front of the phone body. If the disk-shaped compound hologram records a dynamic image, the hologram seat would be rotated by the driving mechanism and the compound hologram would be turned by the hologram seat as well. Under the irradiation of the LED toward the rebuilt image, a dynamic and rotative cartoon image could be presented at the front of the phone window 94.

Referring to FIG. 15, a notebook capable of rebuilding holograms in accordance with the present invention includes a main body with a window 94; the LED, hologram seat, driving mechanism, and disk-shaped compound hologram as mentioned supra are mounted within the window 94. The LED and the driving mechanism electrically connect to a power supply of the notebook, and the hologram seat is disposed at the front of the LED for engaging with the driving mechanism. The disk-shaped compound hologram is disposed on the hologram seat. As long as the disk-shaped compound hologram records a static image, like a cartoon figure as shown in FIG. 15, the driving mechanism would not operate. Under the irradiation of the LED toward the rebuilt notebook, a static cartoon image could be presented at the front of the notebook body. If the disk-shaped compound hologram records a dynamic image, the hologram seat would be rotated by the driving mechanism and the compound hologram would be turned by the hologram seat as well. Under the irradiation of the LED toward the rebuilt image, a dynamic and rotative cartoon image could be presented at the front of the notebook window 94.

A camera capable of rebuilding holograms in accordance with the present invention includes a main body with a window; the LED, hologram seat, driving mechanism, and disk-shaped compound hologram as mentioned supra are mounted within the window. The LED and the driving mechanism electrically connect to a power supply of the camera, and the hologram seat is disposed at the front of the LED for engaging with the driving mechanism. The disk-shaped compound hologram is disposed on the hologram seat. As long as the disk-shaped compound hologram records a static image, the driving mechanism would not operate. Under the irradiation of the LED toward the rebuilt image, a static image could be presented at the front of the camera body. If the disk-shaped compound hologram records a dynamic image, the hologram seat would be rotated by the driving mechanism and the compound hologram would be turned by the hologram seat as well. Under the irradiation of the LED toward the rebuilt image, a dynamic and rotative image could be presented at the front of the camera window.

Referring to FIG. 16, a display projector capable of rebuilding holograms in accordance with the present invention includes a main body with a window 94; the LED, hologram seat, driving mechanism, and disk-shaped compound hologram as mentioned supra are mounted within the window 94. The LED and the driving mechanism electrically connect to a power supply of the display projector, and the hologram seat is disposed at the front of the LED for engaging with the driving mechanism. The disk-shaped compound hologram is disposed on the hologram seat. As long as the disk-shaped compound hologram records a static image, as in FIG. 16 showing a stereo car, the driving mechanism would not operate. Under the irradiation of the LED toward the rebuilt image, a stereo car image could be statically presented at the front of the display projector body. If the disk-shaped compound hologram records a dynamic image, the hologram seat would be rotated by the driving mechanism and the compound hologram would be turned by the hologram seat as well. Under the irradiation of the LED toward the rebuilt image, a dynamic and rotative car image could be presented at the front of the display projector window 94.

While we have shown and described the embodiment in accordance with the present invention, it should be clear to those skilled in the art that further embodiments may be made without departing from the scope of the present invention.

1. A holographic reconstructing device including a compound hologram, a hologram seat, and a rebuilding light; characterized in that said compound hologram being shaped of a flat-disk contour and disposed on said hologram seat; said rebuilding light adopting an LED and being disposed beneath said hologram seat.

2. The device as claimed in claim 1, wherein said hologram seat is identical to a body of said holographic reconstructing device.

3. The device as claimed in claim 1, wherein said device further includes a driving mechanism serving to rotate said hologram seat and thence drive a rotation of said compound hologram.

4. The device as claimed in claim 3, wherein said driving mechanism includes a motor and a decelerating gear assembly; said decelerating gear assembly has a small gear and a large gear; said small gear connects to said motor, and said large gear attaches to a circumference of said hologram seat, thus allowing said motor to rotate said hologram seat by said decelerating gear assembly.

5. The device as claimed in claim 3, wherein said driving mechanism is a combination of motor and band wheel or a combination of motor and chain.

6. The device as claimed in claim 3, wherein said device includes a body; said hologram seat is rotatably mounted on said body, and said driving mechanism and said LED are mounted on said body.

7. The device as claimed in claim 1, wherein said LED is made by white light.

8. The device as claimed in claim 1, wherein said LED is made by mono-colorful light.

9. The device as claimed in claim 1, wherein said LED is made by light with an assortment of colors whose color variation and combination are manipulated by a program controller.

10. The device as claimed in claim 1, wherein a reference beam is coaxial with respect to a spindle of a disk plate when said compound hologram is under shooting; said LED is disposed on a substrate right below said hologram seat and located true to an axis of said compound hologram.

11. The device as claimed in claim 1, wherein a reference beam deviates from a spindle of a disk plate when said compound hologram is under shooting; said LED is disposed on a substrate under said hologram seat and located off an axis of said compound hologram.

12. The device as claimed in claim 1, wherein said compound hologram has adjacent twice exposure areas that are overlapped.

13. The device as claimed in claim 1, wherein a transparent protective layer covers a surface where said compound hologram contacts with the outside.

14. The device as claimed in claim 13, wherein said transparent protective layer is made of glass, PET, or PMMA.

15. The device as claimed in claim 1, 10, 11, 12, or 13, wherein, under the shooting of said compound hologram, a camera shooting angle is ranged from 30° to 40°, a revolving angle of said disk plate and an object is ranged from 0.1° to 1°, an incident angle of an object beam is ranged from 30° to 45°, and a distance between a convergence of said object beam and said disk plate is ranged from 10 to 20 cm.

16. A portable electronic product capable of rebuilding holograms includes a main body with a window; said holographic reconstructing device as claimed supra from claims 1 to 14 being mounted within said window and electrically connecting to a power supply of said electronic product.

17. The product as claimed in claim 16, wherein said portable electronic product adopts a mobile phone, a notebook, a PDA, a camera, and a projector.

18. A portable electronic product capable of rebuilding holograms includes a main body with a window; said holographic reconstructing device as claimed supra in claim 15 being mounted within said window and electrically connecting to a power supply of said electronic product.

19. The product as claimed in claim 18, wherein said portable electronic product adopts a mobile phone, a notebook, a PDA, a camera, and a projector.
